(19) United States
(12) Patent Application Publication
(10) Pub. No.: US 2015/0150093 A1
(43) Pub. Date: May 28, 2015

(54) METHOD AND DEVICE FOR PROCESSING SOCIAL NETWORK MESSAGES

(71) Applicant: INSTITUTE FOR INFORMATION INDUSTRY, Taipei (TW)

(72) Inventors: Wen-Tai Hsieh, Taipei City (TW); Ping-Che Yang, Kaohsiung City (TW); Chien-Yuan Wang, Tainan City (TW)

(73) Assignee: INSTITUTE FOR INFORMATION INDUSTRY, Taipei (TW)

(21) Appl. No.: 14/288,492

(22) Filed: May 28, 2014

(30) Foreign Application Priority Data
Nov. 22, 2013 (TW) 102142665

(51) Int. Cl. H04L 29/06; G06F 17/22

(52) U.S. Cl. CPC H04L 63/08; G06F 17/2235
USPC 726/4; 715/205

(57) ABSTRACT

A method for processing social network messages includes the following steps. Receive a specified web page request signal through a network from a client device. Acquire identification information of a first user account. Embed the identification information into an address of the specified web page to generate a first sharing linking address corresponding to the first user account. Post a sharing message on the personal-message-posting web page. Record operating information and corresponding operating time for at least one second user account when linking to the first sharing linking address. When the operation is sharing operation, embed identification information corresponding to the at least one second user account into the first sharing linking address, generate a second sharing linking address corresponding to the at least one second user account, and post the sharing message on the personal-message-posting web page of the at least one second user account.

### RELATED APPLICATIONS

This application claims priority to Taiwan Application Serial Number 102142665, filed Nov. 22, 2013, the entirety of which is herein incorporated by reference.

### BACKGROUND

1. Technical field

The present disclosure relates to a social network messages processing method and device.

2. Description of Related Art

With the development of Internet, various network services have been invented and provided. Among them, the social network service can provide a platform for people to communicate and has become a popular network service.

The mass number of social network users has brought a lot of business opportunities. Advertisement matching or marketing tools are used to promote the advertisement business on the social network. In order to precisely promote the advertisement business or evaluate the effects of advertisements, it is very important to obtain the propagating amount of the social network users and the propagating path information. For example, Facebook provides fan pages and the Insight tool to evaluate the amount of participating users. However, the propagating paths between users can not be analyzed by the above tool.

Therefore, how to analyze the marketing propagating paths on the social network has become a very important issue in this field.

### SUMMARY

In one aspect, the present disclosure is related to a method for processing social network messages. In the method for processing social network messages, corresponding linking addresses are generated for recording and analyzing, according to identification information of user accounts. The method for processing social network messages includes the following steps. Receive a specified web page request signal through a network from a client device by a server, in which the client device corresponds to a first user account of a social network system, and the specified web page request signal is utilized to request to link a specified web page to a personal-message-posting web page of the first user account of the social network system. Acquire identification information of the first user account by the server. Embed the identification information into an address of the specified web page to generate a first sharing linking address corresponding to the first user account by the server. Post a sharing message on the personal-message-posting web page of the social network system according to contents of the specified web page and the first sharing linking address by the server. By the server, record operating information and corresponding operating time for at least one second user account of the social network system when linking to the first sharing linking address, in which the operating information is operation on sharing messages of the first sharing linking address, and when the operation is sharing operation, the server embeds identification information corresponding to the at least one second user account into the first sharing linking address, generates a second sharing linking address corresponding to the at least one second user account, and posts the sharing message on the personal-message-posting web page of the at least one second user account of the social network system according to contents of the specified web page and the second sharing linking address of the at least one second user account. The abovementioned operation can be a hit, clicking like, leaving a message, sharing, buying products, forwarding, recommending or other operations on the sharing message.

In another aspect, the present disclosure is related to a method for processing social network messages including the following steps. Receive a specified web page request signal through a network from a client device by a server, in which the client device corresponds to a first user account of a social network system, and the specified web page request signal is utilized to request to link a specified web page to a personal-message-posting web page of the first user account of the social network system. Acquire identification information of the first user account by the server. Embed the identification information into an address of the specified web page to generate a first sharing linking address corresponding to the first user account by the server. Post a sharing message on the personal-message-posting web page of the social network system according to contents of the specified web page and the first sharing linking address by the server. By the server, record operating information and corresponding operating time for at least one second user account of the social network system when linking to the first sharing linking address, in which the operating information is operation on sharing messages of the first sharing linking address. When the operating information is hit operation, the server records hit information of the first sharing linking address and the corresponding at least one second user account. When the operation is sharing operation, the server embeds identification information corresponding to the at least one second user account into an address of the specified web page to generate a second sharing linking address corresponding to the at least one second user account, and posts the sharing message on the personal-message-posting web page of the at least one second user account of the social network system according to contents of the specified web page and the second sharing linking address of the at least one second user account. The abovementioned operation can be a hit, clicking like, leaving a message, sharing, buying products, forwarding, recommending or other operations on the sharing message.

In another aspect, the present disclosure is related to a social network messages processing device including a network card and a processing unit. The network card is configured for building connection with a network. The processing unit is electrically connected with the network card. The processing unit includes a receiving module, an identification information processing module, a posting module and a recording module. The receiving module is configured for driving the network card to receive a specified web page request signal through a network from a client device, in which the client device corresponds to a first user account of a social network system, and the specified web page request signal is utilized to request to link a specified web page to a personal-message-posting web page of the first user account of the social network system. The identification information processing module is configured for acquiring identification information of the first user account, and embedding the identification information into an address of the specified web page to generate a first sharing linking address corresponding to the first user account. The posting module is configured for posting a sharing message on the personal-message-posting web page of the social network system according to contents of the specified web page and the first sharing linking address. The recording module is configured for recording operating information and corresponding operating time for at least one second user account of the social network system when linking to the first sharing linking address, wherein the operating information is operation on sharing messages of the first sharing linking address. When the operation is sharing operation, the identification information processing module embeds identification information corresponding to the at least one second user account into the first sharing linking address, generates a second sharing linking address corresponding to the at least one second user account, and posts the sharing message on the personal-message-posting web page of the at least one second user account of the social network system according to contents of the specified web page and the second sharing linking address of the at least one second user account. The abovementioned operation can be a hit, clicking like, leaving a message, sharing, buying products, forwarding, recommending or other operations on the sharing message.

In another aspect, the present disclosure is related to a social network messages processing device including a network card and a processing unit. The network card is configured for building connection with a network. The processing unit is electrically connected with the network card. The processing unit includes a receiving module, an identification information processing module, a posting module and a recording module. The receiving module is configured for driving the network card to receive a specified web page request signal through a network from a client device, in which the client device corresponds to a first user account of a social network system, and the specified web page request signal is utilized to request to link a specified web page to a personal-message-posting web page of the first user account of the social network system. The identification information processing module is configured for acquiring identification information of the first user account, and embedding the identification information into an address of the specified web page to generate a first sharing linking address corresponding to the first user account. The posting module is configured for posting a sharing message on the personal-message-posting web page of the social network system according to contents of the specified web page and the first sharing linking address. The recording module is configured for recording operating information and corresponding operating time for at least one second user account of the social network system when linking to the first sharing linking address, in which the operating information is operation on sharing messages of the first sharing linking address. When the operating information is hit operation, the recording module further records hit information of the first sharing linking address and the corresponding at least one second user account. When the operation is sharing operation, the identification information processing module embeds identification information corresponding to the at least one second user account into an address of the specified web page to generate a second sharing linking address corresponding to the at least one second user account, and the posting module posts the sharing message on the personal-message-posting web page of the at least one second user account of the social network system according to contents of the specified web page and the second sharing linking address of the at least one second user account.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow chart of a social network messages processing method in accordance with one embodiment of the present disclosure;

FIG. 2 is a flow chart of another social network messages processing method in accordance with one embodiment of the present disclosure;

FIG. 3 is a block diagram of a social network messages processing device in accordance with one embodiment of the present disclosure;

FIG. 4 is a block diagram of another social network messages processing device in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

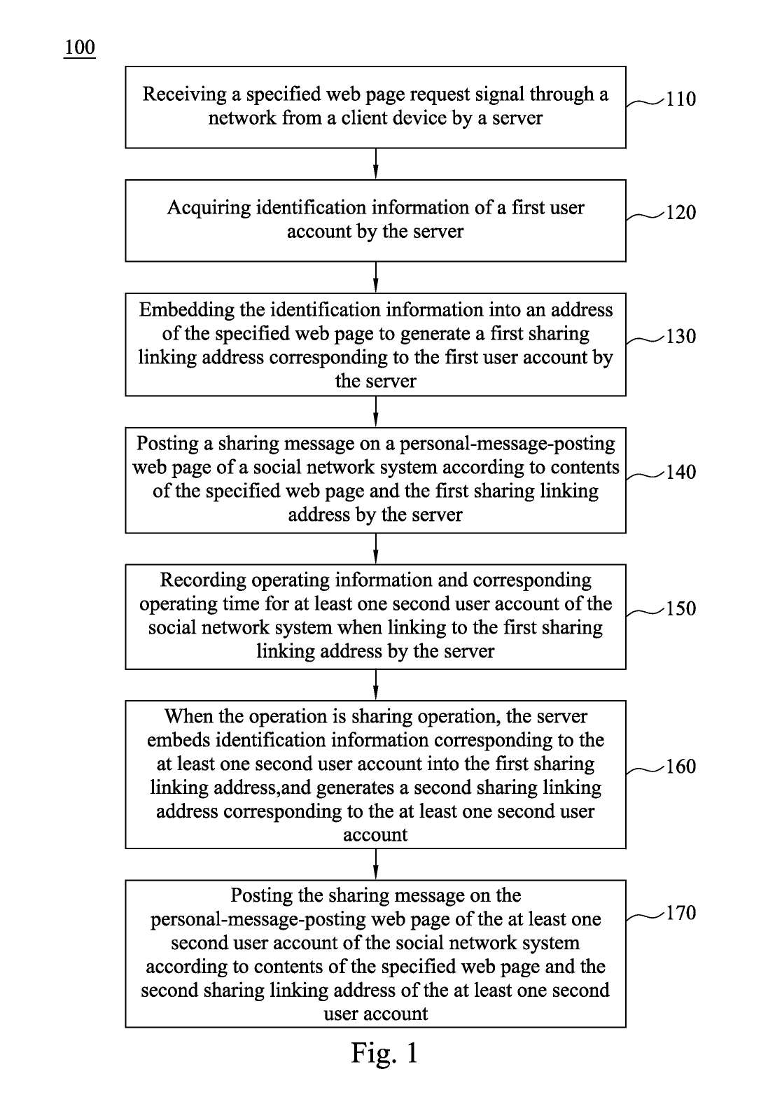

Reference is made first to FIG. 1. FIG. 1 is a flow chart of a social network messages processing method 100 in accordance with one embodiment of the present disclosure. In the social network messages processing method 100, corresponding linking addresses are generated for recording and analyzing according to identification information of user accounts. The social network messages processing method 100 can be implemented by a social network messages processing device. The social network messages processing method 100 may also take the form of a computer program stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The social network messages processing method 100 includes the following steps:

In step 110, receive a specified web page request signal through a network from a client device by a server. The client device corresponds to a first user account of a social network system. For example, a user can login the social network system by operating a client device such that the client device corresponds to the first user account of the social network system. The specified web page request signal is utilized to request to link a specified web page to a personal-message-posting web page of the first user account of the social network system. The specified web page can be a web page for a specified activity or other specified web page, for example, a web page for advertisements of the specified activity, a web page for a lottery or a web page for a notice of the specified activity. After the specified web page is linked to the personal-message-posting web page, the server could obtain the authority for the first user account to post information on the personal-message-posting web page of the social network system. In other embodiments, the server could obtain the authority by providing an authorization page and receiving the reply by the user. The server obtains the authority for the first user account to access data or post information on the personal-message-posting web page of the social network system or on other personal-message-posting web pages obtained through the link.

In step 120, acquire identification information of the first user account by the server. For example, the identification information of the first user account could be an identification number of the first user account, the name of the first user account, or other ID/names/information which could be corresponding to the first user account. In some embodiments, the server can create identification information for each user account in advance. When the user logins the first user account of the social network system through the client device and the server receives the specified web page request signal, the server can acquire the first user account from the client device and then acquire the identification information corresponding to the first user account from said created identification information for each user account. In other embodiments, the server can generate corresponding identification information according the first user account instead of creating the identification information for each user account. In other additional embodiments, the server can create corresponding identification information for the first user account according to pre-defined rules.

In step 130, embed the identification information into an address of the specified web page to generate a first sharing linking address corresponding to the first user account by the server. For example, the server can attach the identification information of the first user account to the end of the web page address of the specified web page, to the position after a specified character/string, or to other specified position in the web page address of the specified web page. Moreover, the first sharing linking address can not only appear in the form of words but also in the form of two-dimensional (2D) barcodes. In some embodiments, the identification information can first be processed (for example, encryption or computed by specified formulas) and then be embedded into the web page address of the specified web page.

In step 140, post a sharing message on the personal-message-posting web page of the social network system according to contents of the specified web page and the first sharing linking address by the server. Thus other users who can access the personal-message-posting web page of the first user account of the social network system are able to connect the first sharing linking address by reading the sharing message.

In step 150, record operating information and corresponding operating time for at least one second user account of the social network system when linking to the first sharing linking address by the server. The operating information is operation on sharing messages of the first sharing linking address. For example, the operation can be but not limited to a hit, clicking like, leaving a message, sharing, buying products, forwarding, recommending or other operations. In other words, when the server detects that a user is linking to the specified web page via the first sharing linking address, the server can record it as the operating information for the at least one second user account when linking to the first sharing linking address so as to record the corresponding operation time.

In step 160, when the operation is sharing operation, the server embeds identification information corresponding to the at least one second user account into the first sharing linking address, and generates a second sharing linking address corresponding to the at least one second user account. For example, the server can attach the identification information of the second user account to the end of the first sharing linking address, to the position after a specified character/string, or to other specified position. Thus the second sharing linking address can at the same time record the identification information corresponding to the first user account and the second user account and the orders thereof, which could be used for further analysis and therefore the information propagating path can be understood.

In step 170, post the sharing message on the personal-message-posting web page of the at least one second user account of the social network system according to contents of the specified web page and the second sharing linking address of the at least one second user account. Thus other users who can access the personal-message-posting web page of the second user account of the social network system are able to connect the second sharing linking address by reading the sharing message.

Furthermore, in some embodiments of the social network messages processing method 100, before step 130, an authorization requesting page can be transmitted to the client device through the network by the server. Thus after the user operates the authorization requesting page to authorize, an authorization-confirmation message corresponding to the first user account from the client device for granting at least one authority of the first user account in the social network system can be received. For example, the authority granting the first user account to access data, personal data, friends data, fans data or post information on the personal-message-posting web page of the social network system, or on other personal-message-posting web pages obtained through the link. After obtaining the authority from the user, the server can obtain corresponding data of the user and his/her friends, the operation data for the specified web page, responding data or other data such that the propagating path could be generated then.

Moreover, in some embodiments of the social network messages processing method 100, the following steps can be included after step 150. When more than one people operate to link the first sharing linking address by hit operation such that the number of the at least one second user account is plural, the recorded operating information and corresponding operating time for the second user account of the social network system when linking to the first sharing linking address can be calculated and analyzed by the server to obtain one of an amount of propagating hits, an amount of propagating responses and an amount of propagating reaches. The amount of the hit of other users which were brought by the first sharing linking address is the amount of propagating hits amount of the first user corresponding to the first sharing linking address. Furthermore, the amount of response of the first sharing linking address on the social network web page (for example, clicking like, leaving a message, or sharing) can be connected based on the authority of the first user account on the social network web page granted by the user. The above-mentioned amount of response can be regarded as the amount of propagating responses of the user. The number of friends, fans or the combination thereof who access the first user account is regarded as the amount of propagating reaches of the first user (i.e., the number of people who may be reached through propagating).

Furthermore, in other embodiments of the social network messages processing method 100, the following steps can be included after step 170. By the server, build a propagation-influence-path graph according to the sharing linking addresses corresponding to the first user account, the second user accounts and other user accounts. The propagation-influence-path graph includes a plurality of nodes. Each node of the propagation-influence-path graph corresponds to one of the user accounts, and directions of connected lines between the nodes are generated according to orders of identification information of the sharing linking address corresponding to each user account. Thus the directional connected lines between the nodes can represent the connections between the user accounts so as to represent the propagation-influence-paths. Therefore, it could be understood that by what orders the specified web page is propagated to other users.

Moreover, in other embodiments of the social network messages processing method 100, the following steps can be included before step 130. By the server, transmit an authorization-confirmation message via the network to obtain an authorization to access age information of the first user account, the second user account and other user accounts of the social network system. Thus each node of the propagation-influence-path graph can be grouped and colored according to the age information to build a grouped propagation-influence-path graph. In this way, the propagating situation between various age regions can be analyzed.

Furthermore, the user account corresponding to each of the nodes of the propagation-influence-path graph can conceal part of a user name by utilizing an encryption to build a privacy-protected propagation-spreading-path graph. Thus user privacy will not be leaked out on the propagation-spreading-path graph. A sum of number of people at first layer of the propagation-spreading-path graph means number of direct-propagation people, and sum of number of people at second and other layers of the propagation-spreading-path graph means number of indirect-propagation people.

Moreover, in other embodiments of the social network messages processing method 100, the specified web page is a fan page of the social network system and the following steps can be included before step 120. By the server, determine whether the first user account, the second user accounts and other user accounts of the social network system are fans for the fan page. When a user account is determined as the fan of the fan page, then execute step 120. When a user account is determined not the fan of the fan page, transmit a request windows asking users to be fans for the fan page, and receive confirmation messages of agreement to be fans for the fan page from the first user account, the second user accounts and other user accounts via the network.

In other embodiments of the social network messages processing method 100, an application or a specified web page address can be provided to the client device. The specified web page request signal illustrated in step 110 is generated by the client device when the client device executes the application or connects to the specified web page address.

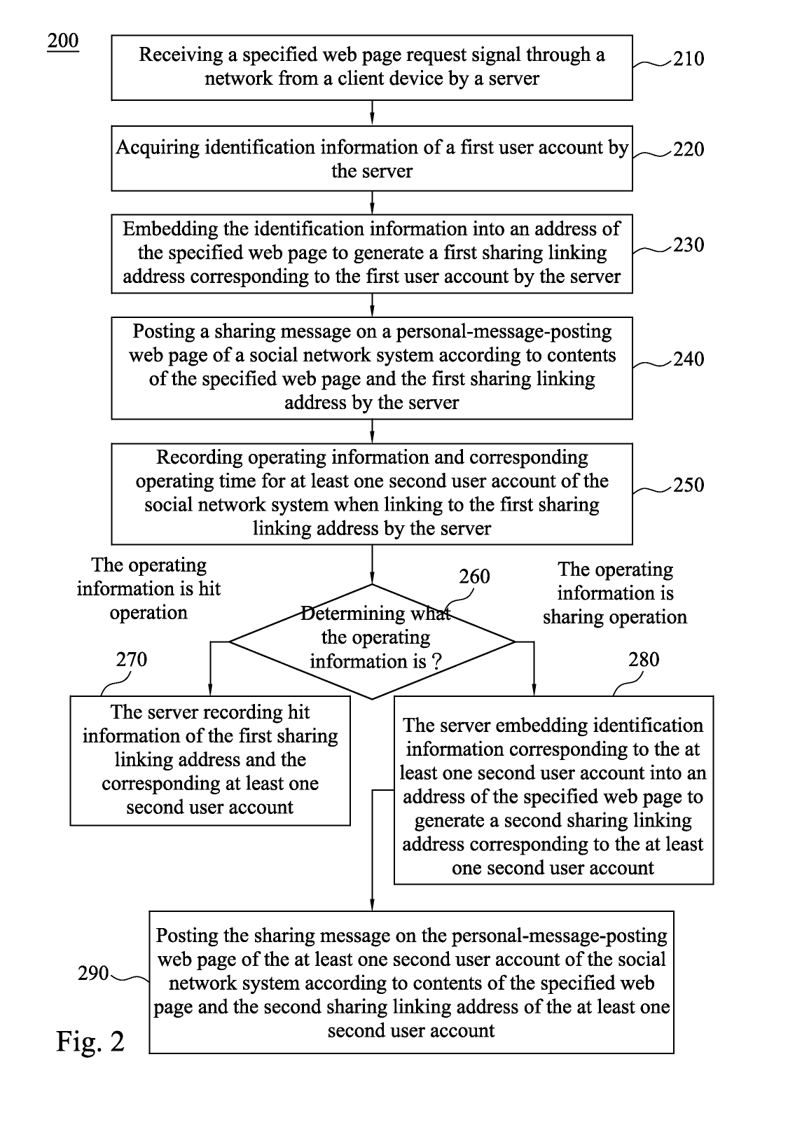

Reference is made also to FIG. 2. FIG. 2 is a is a flow chart of a social network messages processing method 200 in accordance with one embodiment of the present disclosure. The social network messages processing method 200 can be implemented by a social network messages processing device. The social network messages processing method 200 may also take the form of a computer program product stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The social network messages processing method 200 includes the following steps.

In step 210, receive a specified web page request signal through a network from a client device by a server. The client device corresponds to a first user account of a social network system. The specified web page request signal is utilized to request to link a specified web page to a personal-message-posting web page of the first user account of the social network system.

In step 220, acquire identification information of the first user account by the server.

In step 230, embed the identification information into an address of the specified web page to generate a first sharing linking address corresponding to the first user account by the server.

In step 240, post a sharing message on the personal-message-posting web page of the social network system according to contents of the specified web page and the first sharing linking address by the server. Thus other users who can access the personal-message-posting web page of the first user account of the social network system are able to connect the first sharing linking address by reading the sharing message.

In step 250, record operating information and corresponding operating time for at least one second user account of the social network system when linking to the first sharing linking address by the server. The operating information is operation on sharing messages of the first sharing linking address.

Then in step 260, determine what the operating information is.

In step 270, when the operating information is hit operation, the server records hit information of the first sharing linking address and the corresponding at least one second user account.

In step 280, when the operation is sharing operation, the server embeds identification information corresponding to the at least one second user account into an address of the specified web page to generate a second sharing linking address corresponding to the at least one second user account. In this embodiment, the second sharing linking address does not include the identification information of the first user. Later, when the server builds the propagation-influence-path graph, the relationships between nodes of the propagation-influence-path graph are decided according to the recorded first sharing linking address and the corresponding hit information of the second user account.

Then in step 290, post the sharing message on the personal-message-posting web page of the at least one second user account of the social network system according to contents of the specified web page and the second sharing linking address of the at least one second user account. Thus the sharing message posted on the personal-message-posting web page of the at least one second user account of the social network system does not include the identification information of the first user.

Furthermore, in other embodiments of the social network messages processing method 200, a propagation-influence-path graph can be built according to the first sharing linking addresses recorded by the server, the corresponding hit information of the second user account, the first sharing linking address and the second sharing linking address. Each node of the propagation-influence-path graph corresponds to one of the user accounts, and directions of connected lines between the nodes are generated according to records of the user accounts of each node clicking the user accounts of other node. Thus even the second sharing linking address does not include the identification of the first user account, it can be understood that the user clicking the second sharing linking address finds the specified web page indirectly from the first sharing linking address shared by the first user account such that the information propagating paths between users could be understood.

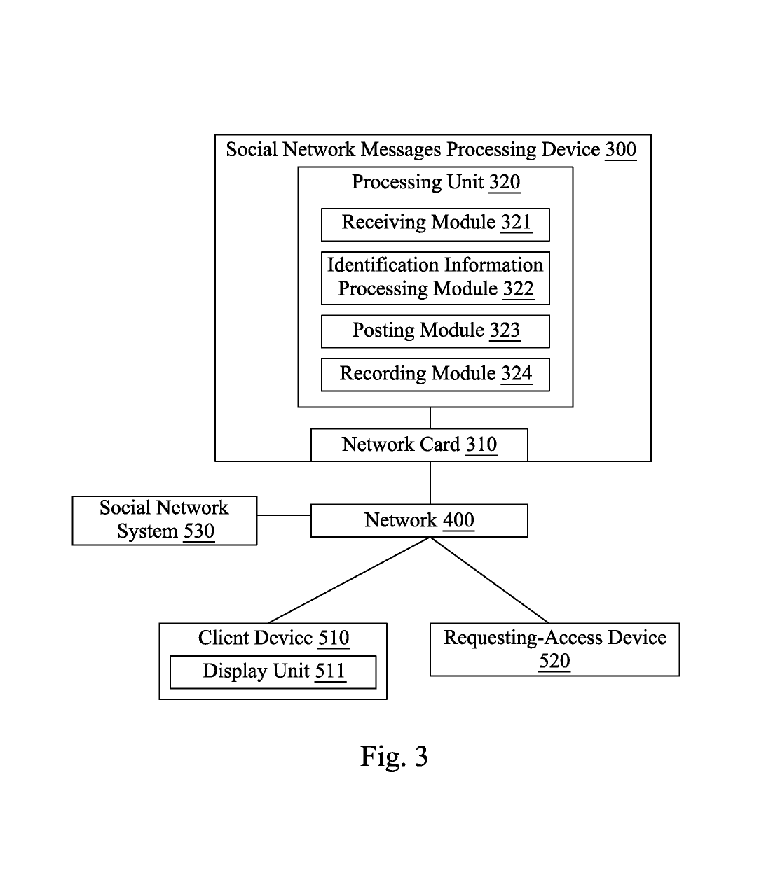

Additional reference is made to FIG. 3. FIG. 3 is a block diagram of a social network messages processing device 300 in accordance with one embodiment of the present disclosure. The social network messages processing device 300 includes a network card 310 and a processing unit 320, which are electrically connected with each other.

The network card 310 can build a connection with a client device 510 via a network 400. The social network messages processing device 300 can be a server, a computer or other electrical devices.

The processing unit 320 can be a Central Processing Unit (CPU), a control unit, a micro processor or other hardware components which can perform commands. Each module of the processing unit 320 can be implemented as a code, which can be stored in storage components. Thus the processing unit 320 can read and execute the codes stored in the storage components so as to provide the corresponding function of each module.

The processing unit 320 includes a receiving module 321, an identification information processing module 322, a posting module 323 and a recording module 324. The receiving module 321 is configured for driving the network card 310 to receive a specified web page request signal through the network 400 from a client device 510. The client device 510 corresponds to a first user account of a social network system 530. For example, a user can operate the client device 510 to login the social network system 530 through the network 400 such that the client device 510 corresponds to a first user account of a social network system 530. The specified web page request signal is utilized to request to link a specified web page to a personal-message-posting web page of the first user account of the social network system 530.

The identification information processing module 322 is configured for acquiring identification information of the first user account. For example, the identification information of the first user account can be an identification number of the first user account, the name of the first user account or other information which could be used to identified. The identification information processing module 322 embeds the identification information into an address of the specified web page to generate a first sharing linking address corresponding to the first user account. For example, the identification information processing module 322 attaches the identification information to the end of the web page address of the specified web page, to the position after a specified character/string, or other specified position of the web page address of the specified web page to generate the first sharing linking address.

The posting module 323 is configured for posting a sharing message on the personal-message-posting web page of the social network system 530 according to contents of the specified web page and the first sharing linking address. Thus, other users who can access the personal-message-posting web page of the first user account of the social network system 530 are able to link the first sharing linking address by operating other devices to read the sharing message via the network 400.

The recording module 324 is configured for recording operating information and corresponding operating time for at least one second user account of the social network system 530 when linking to the first sharing linking address. The operating information is operation on sharing messages of the first sharing linking address. In other words, when another user operates other devices (for example, the requesting-access device 520) to perform operation on the first sharing linking address, the recording module 324 regards the account being used by the user as the second user account

When the operation is sharing operation, the identification information processing module 322 embeds identification information corresponding to the at least one second user account into the first sharing linking address to generate a second sharing linking address corresponding to the at least one second user account. For example, the identification information processing module 322 of the processing unit 320 attaches the identification information of the second user account to the end of the first sharing linking address of the first user of the specified web page to generate the second sharing linking address corresponding to the second user account. Thus the second sharing linking address can at the same time record the identification information corresponding to the first user account and the second user account and the orders thereof, which could be used for further analysis and therefore the information propagating path can be understood.

The posting module 323 is configured for posting the sharing message on the personal-message-posting web page of the second user account of the social network system 530 according to contents of the specified web page and the second sharing linking address of the at least one second user account. Thus other users who can access the personal-message-posting web page of the second user account of the social network system 530 are able to operate to link the second sharing linking address by reading the sharing message via the network 400.

Furthermore, in some embodiments, the processing unit 320 can further include an authorization processing module (not depicted in FIG. 3). The authorization processing module is configured for driving the network card 310 to transmit an authorization requesting page to the client device 510 through the network 400 such that the display unit 511 can display the authorization requesting page. Thus after the user of the client device 510 operates the authorization requesting page to authorize, an authorization-confirmation message corresponding to the first user account is received from the client device 510 for granting at least one authority of the first user account in the social network system 530. For example, the authority granting the first user account to access data, post information on the personal-message-posting web page of the social network system, or on other personal-message-posting web pages obtained through the link.

Moreover, in some embodiments, when more than one people operate to link the first sharing linking address by hit operation such that the number of the at least one second user account is plural, the processing unit 320 can further includes an analysis module (not depicted in FIG. 3). The analysis module is configured for calculating and analyzing the recorded operating information and corresponding operating time for the second user account of the social network system 530 when linking to the first sharing linking address, to obtain one of an amount of propagating hits, an amount of propagating responses and an amount of propagating reaches. The amount of the hit of other users which were brought by the first sharing linking address is the amount of propagating hits amount of the first user corresponding to the first sharing linking address. Furthermore, the amount of response of the first sharing linking address on the social network web page (for example, clicking like, leaving a message, or sharing) can be connected based on the authority of the first user account on the social network web page granted by the user. The above-mentioned amount of response can be regarded as the amount of propagating responses of the user. The number of friends, fans or the combination thereof who access the first user account is regarded as the amount of propagating reaches of the first user (i.e., the number of people who may be reached through propagating).

In other embodiments, the processing unit 320 can further include a building module (not depicted in FIG. 3). The building module is configured for building a propagation-influence-path graph according to the sharing linking addresses corresponding to the first user account, the second user accounts and other user accounts. Each node of the propagation-influence-path graph corresponds to one of the user accounts, and directions of connected lines between the nodes are generated according to orders of identification information of the sharing linking address corresponding to each user account. Thus the directional connected lines between the nodes can represent the connections between the user accounts so as to represent the propagation-influence-paths. Therefore, it could be understood that by what orders the specified web page is propagated to other users.

Moreover, in other embodiments, the processing unit 320 can further include an authorization confirmation module (not depicted in FIG. 3). The authorization confirmation module is configured driving the network card 310 to transmit an authorization-confirmation message via the network 400 to obtain an authorization to access age information of the first user account, the second user account and other user accounts of the social network system 530. Thus each node of the propagation-influence-path graph can be grouped and colored according to the age information to build a grouped propagation-influence-path graph. In this way, the propagating situation between various age regions can be analyzed.

Furthermore, in other embodiments, the processing unit 320 can further include an encryption module (not depicted in FIG. 3). The encryption module is configured for concealing part of a user name of the user account corresponding to each of the nodes of the propagation-influence-path graph by utilizing an encryption method so as to build a privacy-protected propagation-spreading-path graph. Thus user privacy will not be leaked out on the propagation-spreading-path graph. A sum of number of people at first layer of the propagation-spreading-path graph means number of direct-propagation people, and sum of number of people at second and other layers of the propagation-spreading-path graph means number of indirect-propagation people.

In other embodiments, the specified web page can be a fan page of the social network system 530. The processing unit 320 can further include a determining module (not depicted in FIG. 3). The determining module is configured for determining whether the first user account, the second user accounts and other user accounts of the social network system 530 are fans for the fan page. When a user account is determined not the fan of the fan page, the processing unit 320 drives the network card 310 to transmit a request windows/page asking users to be fans for the fan page, and receive confirmation messages of agreement to be fans for the fan page from the first user account, the second user accounts and other user accounts via the network 400.

In other embodiments, the processing unit 320 can further include a providing module (not depicted in FIG. 3). The providing module is configured for providing an application or a specified web page address to the client device 510. The specified web page request signal is generated by the client device 510 when the client device 510 executes the application or operates to link to the specified web page address.

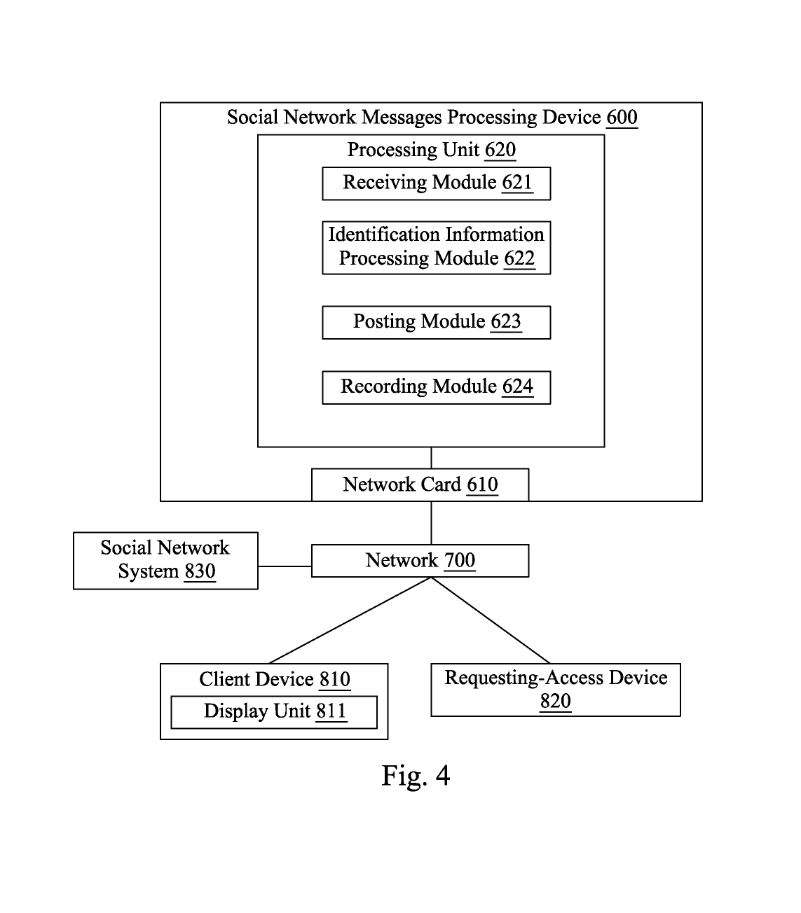

Reference is now made to FIG. 4. FIG. 4 is a block diagram of a social network messages processing device 600 in accordance with one embodiment of the present disclosure. The functions and operations of the network card 610, the receiving module 621, the identification information processing module 622 and the posting module 623 are similar to the network card 310, the receiving module 321, the identification information processing module 322 and the posting module 323 illustrated in FIG. 3 and hence are not described again herein. The difference between the embodiment illustrated in FIG. 4 and the embodiment illustrated in FIG. 3 is explained as follows.

The main difference between the embodiment illustrated in FIG. 4 and the embodiment illustrated in FIG. 3 is that the recording module 624 records the operating information and the corresponding time for at least one second user account of the social network system when linking to the first sharing linking address. The operating information is operation on sharing messages of the first sharing linking address by devices (for example, the requesting-access device 820) operated by other users.

When the operating information is hit operation, the recording module 624 records hit information of the first sharing linking address and the corresponding second user account.

When the operation is sharing operation, the identification information processing module 622 embeds identification information corresponding to the second user account into an address of the specified web page to generate a second sharing linking address corresponding to the at least one second user account. In this embodiment, the second sharing linking address does not include the identification information of the first user. Thus the posting module 623 can post the sharing message on the personal-message-posting web page of the second user account of the social network system 830 according to contents of the specified web page and the second sharing linking address of the at least one second user account. Thus the sharing message posted on the personal-message-posting web page of the second user account does not include the identification information of the first user. However, a propagation-influence-path graph can be built according to the recorded first sharing linking addresses, the corresponding hit information of the second user account, the first sharing linking address and the second sharing linking address.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for processing social network messages, comprising:
receiving a specified web page request signal through a network from a client device by a server, wherein the client device corresponds to a first user account of a social network system, and the specified web page request signal is utilized to request to link a specified web page to a personal-message-posting web page of the first user account of the social network system;
acquiring identification information of the first user account by the server;
embedding the identification information into an address of the specified web page to generate a first sharing linking address corresponding to the first user account by the server;
posting a sharing message on the personal-message-posting web page of the social network system according to contents of the specified web page and the first sharing linking address by the server; and
by the server, recording operating information and corresponding operating time for at least one second user account of the social network system when linking to the first sharing linking address, wherein the operating information is operation on sharing messages of the first sharing linking address, and when the operation is sharing operation, the server embeds identification information corresponding to the at least one second user account into the first sharing linking address, generates a second sharing linking address corresponding to the at least one second user account, and posts the sharing message on the personal-message-posting web page of the at least one second user account of the social network system according to contents of the specified web page and the second sharing linking address of the at least one second user account.

2. The method for processing social network messages of claim 1, further comprising:
by the server, transmitting an authorization requesting page to the client device through the network, so as to receive an authorization-confirmation message corresponding to the first user account from the client device for granting at least one authority in the social network system for the first user account.

3. The method for processing social network messages of claim 1, wherein the first sharing linking address is generated by attaching the identification information to an end of the address of the specified web page, and the second sharing linking address corresponding to the at least one second user account is generated by attaching the identification information corresponding to the at least one second user account to an end of the first sharing linking address.

4. The method for processing social network messages of claim 1, wherein the number of the at least one second user account is plural, and when the operating information is a hit, the method further comprises:
by the server, calculating and analyzing the recorded operating information and corresponding operating time for the second user account of the social network system when linking to the first sharing linking address, to obtain one of an amount of propagating hits, an amount of propagating responses and an amount of propagating reaches.

5. The method for processing social network messages of claim 1, wherein the at least one second user accounts are plural, and the method further comprises:
by the server, building a propagation-influence-path graph according to the sharing linking addresses corresponding to the first user account, the second user accounts and other user accounts, wherein each node of the propagation-influence-path graph corresponds to one of the user accounts, and directions of connected lines between the nodes are generated according to orders of identification information of the sharing linking address corresponding to each user account.

6. The method for processing social network messages of claim 5, further comprising:
by the server, transmitting an authorization-confirmation message through the network to obtain an authorization to access age information of the first user account, the second user account and other user accounts of the social network system; and grouping and coloring each node of the propagation-influence-path graph according to the age information to build a grouped propagation-influence-path graph.

7. The method for processing social network messages of claim 6, wherein the user account corresponding to each of the nodes of the propagation-influence-path graph conceals part of a user name by utilizing an encryption to build a privacy-protected propagation-spreading-path graph, a sum of number of people at first layer of the propagation-spreading-path graph means number of direct-propagation people, and sum of number of people at second and other layers of the propagation-spreading-path graph means number of indirect-propagation people.

8. The method for processing social network messages of claim 1, wherein the number of the at least one second user account is plural, the specified web page is a fan page of the social network system, and the method further comprises:
by the server, determining whether the first user account, the second user accounts and other user accounts of the social network system are fans for the fan page, when a user account is determined not the fan of the fan page, transmitting a request windows asking users to be fans for the fan page, and receiving confirmation messages of agreement to be fans for the fan page from the first user account, the second user accounts and other user accounts through the network.

9. The method for processing social network messages of claim 1, further comprising:
providing an application or a specified web page address to the client device, wherein the specified web page request signal is generated by the client device when the client device executes the application or connects to the specified web page address.

10. A method for processing social network messages, comprising:
receiving a specified web page request signal through a network from a client device by a server, wherein the client device corresponds to a first user account of a social network system, and the specified web page request signal is utilized to request to link a specified web page to a personal-message-posting web page of the first user account of the social network system;
acquiring identification information of the first user account by the server;
embedding the identification information into an address of the specified web page to generate a first sharing linking address corresponding to the first user account by the server;
posting a sharing message on the personal-message-posting web page of the social network system according to contents of the specified web page and the first sharing linking address by the server; and
by the server, recording operating information and corresponding operating time for at least one second user account of the social network system when linking to the first sharing linking address, wherein the operating information is operation on sharing messages of the first sharing linking address, and when the operating information is hit operation, the server records hit information of the first sharing linking address and the corresponding at least one second user account, when the operation is sharing operation, the server embeds identification information corresponding to the at least one second user account into an address of the specified web page to generate a second sharing linking address corresponding to the at least one second user account, and posts the sharing message on the personal-message-posting web page of the at least one second user account of the social network system according to contents of the specified web page and the second sharing linking address of the at least one second user account.

11. The method for processing social network messages of claim 10, wherein the number of the at least one second user accounts is plural, and the method further comprises:
building a propagation-influence-path graph according to the first sharing linking addresses and the corresponding hit information of the at least one second user account, the first sharing linking address and the second sharing linking addresses recorded by the server, wherein each node of the propagation-influence-path graph corresponds to one of the user accounts, and directions of connected lines between the nodes are generated according to records of the user account of each of the nodes hitting the sharing linking addresses of the user accounts of other nodes.

12. A social network messages processing device, comprising:
a network card, configured for building connection with a network; and
a processing unit, electrically connected with the network card, wherein the processing unit comprises:
a receiving module, configured for driving the network card to receive a specified web page request signal through a network from a client device, wherein the client device corresponds to a first user account of a social network system, and the specified web page request signal is utilized to request to link a specified web page to a personal-message-posting web page of the first user account of the social network system;
an identification information processing module, configured for acquiring identification information of the first user account, and embedding the identification information into an address of the specified web page to generate a first sharing linking address corresponding to the first user account;
a posting module, configured for posting a sharing message on the personal-message-posting web page of the social network system according to contents of the specified web page and the first sharing linking address; and
a recording module, configured for recording operating information and corresponding operating time for at least one second user account of the social network system when linking to the first sharing linking address, wherein the operating information is operation on sharing messages of the first sharing linking address, and when the operation is sharing operation, the identification information processing module embeds identification information corresponding to the at least one second user account into the first sharing linking address, generates a second sharing linking address corresponding to the at least one second user account, and posts the sharing message on the personal-message-posting web page of the at least one second user account of the social network system according to contents of the specified web page and the second sharing linking address of the at least one second user account.

13. The social network messages processing device of claim 12, wherein the processing unit further comprises:
an authorization processing module, configured for driving the network card to transmit an authorization requesting page to the client device through the network, so as to receive an authorization-confirmation message corresponding to the first user account from the client device to grant at least one authority in the social network system for the first user account.

14. The social network messages processing device of claim 12, wherein:
the identification information processing module attaches the identification information to an end of the address of the specified web page to generate the first sharing linking address, and
the identification information processing module attaches the identification information corresponding to the at least one second user account to an end of the first sharing linking address corresponding to the first user account of the specified web page to generate the second sharing linking address corresponding to the at least one second user account.

15. The social network messages processing device of claim 12, wherein the number of the at least one second user accounts is plural, and when the operating information is a hit, the method further comprises:
an analysis module, configured for calculating and analyzing the recorded operating information and corresponding operating time for the second user account of the social network system when linking to the first sharing linking address, to obtain one of an amount of propagating hits, an amount of propagating responses and an amount of propagating reaches.

16. The social network messages processing device of claim 12, wherein the number of the at least one second user accounts is plural, and the processing unit further comprises:
a building module, configured for building a propagation-influence-path graph according to the sharing linking addresses corresponding to the first user account, the second user accounts and other user accounts, wherein each node of the propagation-influence-path graph corresponds to one of the user accounts, and directions of connected lines between the nodes are generated according to orders of identification information of the sharing linking address corresponding to each user account.

17. The social network messages processing device of claim 16, wherein the processing unit further comprises:
an authorization confirmation module, configured driving the network card to transmit an authorization-confirmation message through the network to obtain an authorization to access age information of the first user account, the second user account and other user accounts of the social network system; and
grouping and coloring each node of the propagation-influence-path graph according to the age information to build a grouped propagation-influence-path graph.

18. The social network messages processing device of claim 12, wherein the number of the at least one second user accounts is plural, the specified web page is a fan page of the social network system, and the processing unit further comprises:
a determining module, configured for determining whether the first user account, the second user accounts and other user accounts of the social network system are fans for the fan page, when a user account is determined not the fan of the fan page, the processing unit drives the network card to transmit a request windows asking users to be fans for the fan page and receive confirmation messages of agreement to be fans for the fan page from the first user account, the second user accounts and other user accounts through the network.

19. The social network messages processing device of claim 12, wherein the processing unit further comprises:
a providing module, configured for providing an application or a specified web page address to the client device, wherein the specified web page request signal is generated by the client device when the client device executes the application or connects to the specified web page address.

20. A social network messages processing device, comprising:
a network card, configured for building connection with a network; and
a processing unit, electrically connected with the network card, wherein the processing unit comprises:
a receiving module, configured for driving the network card to receive a specified web page request signal through a network from a client device, wherein the client device corresponds to a first user account of a social network system, and the specified web page request signal is utilized to request to link a specified web page to a personal-message-posting web page of the first user account of the social network system;
an identification information processing module, configured for acquiring identification information of the first user account, and embedding the identification information into an address of the specified web page to generate a first sharing linking address corresponding to the first user account;
a posting module, configured for posting a sharing message on the personal-message-posting web page of the social network system according to contents of the specified web page and the first sharing linking address; and
a recording module, configured for recording operating information and corresponding operating time for at least one second user account of the social network system when linking to the first sharing linking address, wherein the operating information is operation on sharing messages of the first sharing linking address, and when the operating information is hit operation, the recording module further records hit information of the first sharing linking address and the corresponding at least one second user account, when the operation is sharing operation, the identification information processing module embeds identification information corresponding to the at least one second user account into an address of the specified web page to generate a second sharing linking address corresponding to the at least one second user account, and the posting module posts the sharing message on the personal-message-posting web page of the at least one second user account of the social network system according to contents of the specified web page and the second sharing linking address of the at least one second user account.
